(19) United States
(12) Patent Application Publication
(10) Pub. No.: US 2005/0091948 A1
(43) Pub. Date: May 5, 2005

(54) Protective vehicle accessory

(76) Inventor: Rhonda Jean Kay, Acworth, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/976,979

(22) Filed: Oct. 29, 2004

Related U.S. Application Data
(60) Provisional application No. 60/516,159, filed on Oct. 31, 2003.

(51) Int. Cl. B01D 50/00

(52) U.S. Cl. 55/385.3

(57) ABSTRACT

A protective cover for a chrome vehicle assembly, wherein the lifespan of the chrome fixture can be increased via the regular utilization of the removable protective cover, wherein the potential for reflective heat transfer from the chrome assembly to surfaces and components located proximate thereto, including fiberglass body parts, is diminished via the insulative qualities of the device, and wherein an attractive outer display surface is provided and is suitable for display of licensed logos and marks, such as CHEVROLET CORVETTE.

### CROSS-REFERENCE TO RELATED APPLICATION

To the full extent permitted by law, the present application claims priority to and the benefit as a non-provisional application to provisional patent application entitled “Protective Vehicle Accessory,” filed on Oct. 31, 2003, having assigned Ser. No. 60/516,159.

### TECHNICAL FIELD

The present invention relates generally to vehicle accessories and, more specifically, to a protective cover for chrome assemblies, wherein resilient, elasticized edges enable secure positioning and wherein material of manufacture provides for reduced heat transfer and for scratch resistive qualities. The present invention is particularly suitable for, although not limited to, use with fiberglass bodied automobiles, such as, for exemplary purposes only, CHEVROLET CORVETTE automobiles.

### BACKGROUND OF THE INVENTION

Car enthusiasts abound. Some such individuals focus their attention on a particular manufacturer of a car, such as, for exemplary purposes only, PORSCHE or FERRARI. Others are drawn to specific body styles, such as, for exemplary purposes only, automobiles having T-tops, or convertibles. Most car enthusiasts, however, have a specific automobile model from a specific manufacturer that remains the primary focus of their interest, and for some, perhaps even from a particular model year.

One type of vehicle that has achieved and maintained a great level of enthusiasm is the CORVETTE by CHEVROLET. The CORVETTE recently celebrated the fiftieth anniversary of its introduction in 1953. Passion for this vehicle has led to the creation of museums, hundreds of private membership clubs on the local, state and national level, and countless web pages devoted to information and trivia related to the CORVETTE.

Many owners of this automobile consider themselves to be a part of a special and select group, or family, and even make an annual pilgrimage to celebrate their cars. Upon gathering at such events, or vehicle shows, cars are typically displayed in a manner that enables the participants to view under the hood, into the trunk, as well as into the interior, so that the vehicle's condition can be fully appreciated. Such activities are common to a variety of makes and models of automobiles, in addition to the CHEVROLET CORVETTE.

One generally unique feature of the CORVETTE, however, is the vehicle's fiberglass body. Characteristics inherent to fiberglass present CORVETTE owners with a different set of care and use guidelines when compared to owners of vehicles manufactured with steel bodies. Additionally, three series of CORVETTES, C1 (1953-1962), C2 (1963-1967), and C3 (1968-1982) were typically provided with extended chrome air filter assemblies that project away from the engine block and toward the interior of the fiberglass hood. To protect the vehicle fiberglass from potentially damaging reflection of the sun's rays by the polished chrome surface, individual owners and display enthusiasts often rely upon the placement or draping of a towel thereover, an unsightly but necessary measure during outdoor car show events. Utilizing a towel or cloth in such a manner is subject to inadvertent slippage, especially because car show displays typically occur out-of-doors, and under windy conditions, the towel can be blown away. Additionally, and of particular concern during competitive display, draping a cloth anywhere over a vehicle's engine is not aesthetically appealing.

Therefore, it is readily apparent that there is a need for a protective cover for a chrome air filter assembly, wherein retentive edges enable secure positioning, and wherein material of manufacture provides for reduced heat transfer and for scratch resistive properties, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a customized protective cover, wherein the device is preferably sized to enable a generally snug fit over a vehicle air filter, distributor, and/or ignition assembly, wherein the structure of the device provides protective shielding to the covered assembly and limits heat transfer therefrom, and wherein the outer surface of the device provides a display area for a logo, insignia or message.

According to its major aspects and broadly stated, the present invention is a protective cover for a chrome assembly, such as an air filter, distributor and/or ignition assembly, wherein the lifespan of the chrome fixture can be increased via the regular utilization of the removable protective cover, wherein the potential for heat reflection from the chrome assembly to surfaces and components located proximate thereto, including fiberglass body parts, is diminished via the insulative qualities of the device, and wherein an attractive outer display surface is provided.

More specifically, the device of the present invention in its preferred form is a protective accessory device having a resilient, adaptable peripheral edge and a defined shape generally related to the geometry of the assembly over which it is to be placed, such as a generally circular shape for a use on a circular air filter assembly or a generally triangular shape for use on a triangular air filter assembly. Accordingly, the preferred embodiment of the present invention enables the protective accessory device to be retained by and to removably cover a vehicle assembly, such as an air filter. In the preferred form, the protective accessory device inhibits reflection, may include heat resistant and flame retardant characteristics, and has a decorative surface, design or coloration displayed and/or attached thereon.

The protective accessory device of the present invention enables the user to protect the lustrous finish of chrome components, as more fully described herein, including, but not limited to, display under the hood of a CORVETTE C1, C2, C3, and/or any other generation of CORVETTE, as part of an extended chrome air filter assembly, wherein insulative qualities of the device provide protection for vehicle components, such as fiberglass body regions, that may be susceptible to heat damage from reflective chrome surfaces which act like a magnifying glass when exposed to the sun.

A feature and advantage of the present invention is the ability of such a device to be securely, yet removably retained on an air filter assembly, or cover.

Another feature and advantage of the present invention is the ability of such a device to be inexpensively produced in a variety of customized sizes.

Another feature and advantage of the present invention is the ability of such a device to protect the chrome finish of an air filter assembly.

Another feature and advantage of the present invention is the ability of such a device to enable a user to efficiently, effectively and reproducibly place and remove the protective covering.

Another feature and advantage of the present invention is the ability of such a device to provide insulative qualities with a decorative display.

Another feature and advantage of the present invention is the ability of such a device to prevent reflection of magnified sunlight onto fiberglass surfaces.

Another feature and advantage of the present invention is its ability to incorporate and display logos, mascot depictions, emblems and notable coloration to enhance visual display and to endorse a vehicle make or model, sports team, patriotic cause, holiday or any other targeted representation.

These and other objects, features and advantages of the invention will become more apparent to one skilled in the art from the following description and claims when read in light of the accompanying drawings:

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a top view of a protective accessory device according to a preferred embodiment of the present invention, showing a licensed logo and trademark displayed thereon;

FIG. 2 is a bottom view of the protective accessory device of FIG. 1;

FIG. 3 is a perspective view of the protective accessory device of FIG. 1, showing the device in place on a chrome air filter assembly;

FIG. 4 is a top view of a protective accessory device according to an alternate embodiment of the present invention; and

FIG. 5 is a top view of a protective accessory device according to another alternate embodiment of the present invention.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

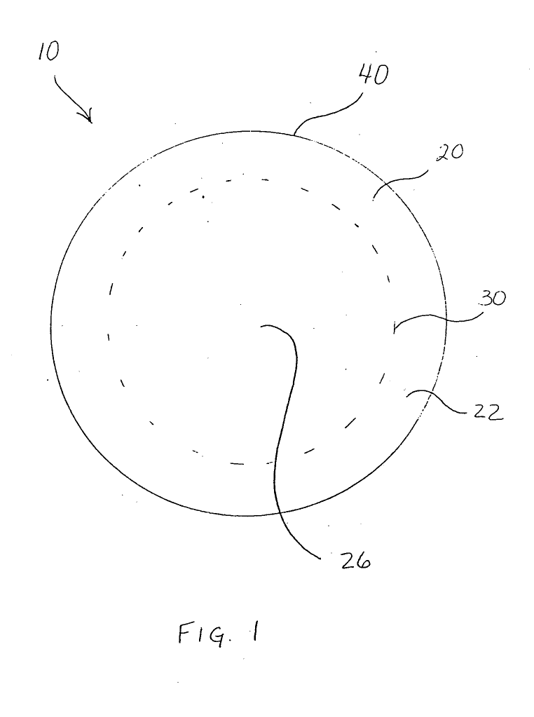

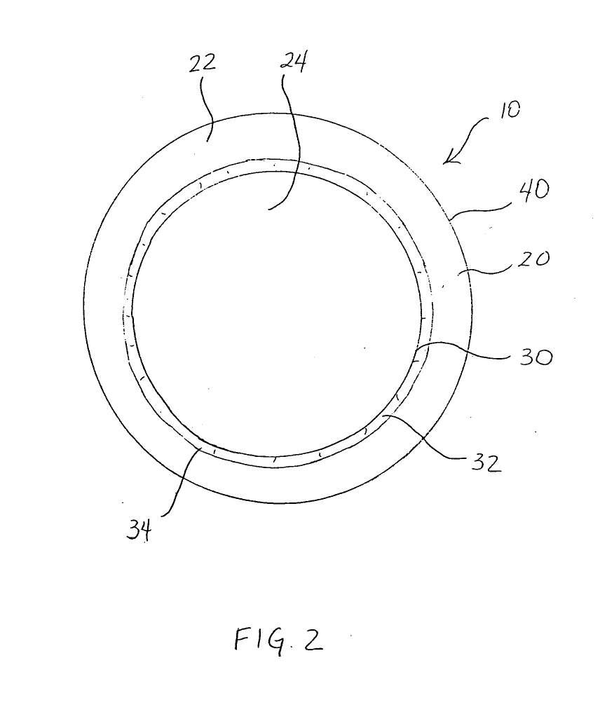

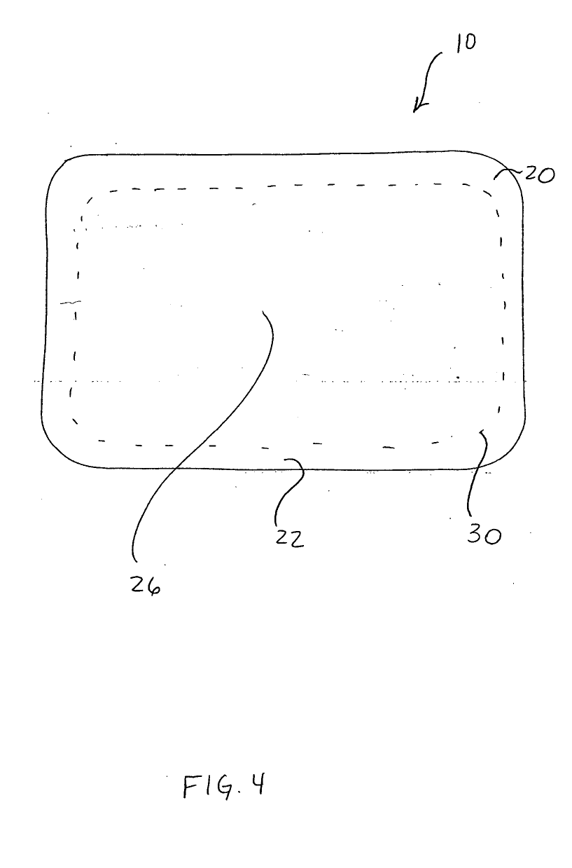

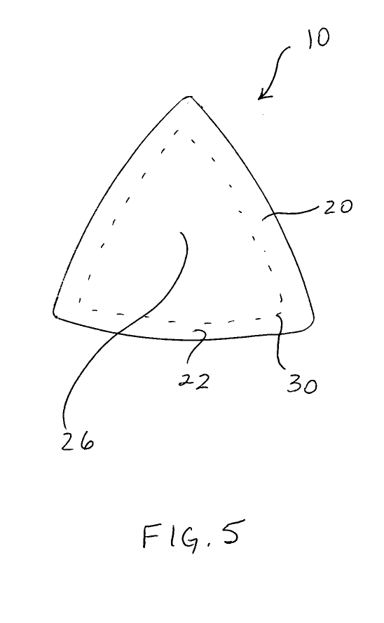

Referring now to FIGS. 1 and 2, the present invention is a protective cover device 10, preferably having generally circular-shaped main body 20 with peripheral edge 30 defined therearound. Although it is preferred that main body 20 is generally circular-shaped, it is anticipated that other shapes could be utilized, such as, for exemplary purposes only, generally triangular, as depicted in FIG. 5, oval (not shown), or rectangular, as depicted in FIG. 4, wherein placement and utilization of cover device 10 over any shaped vehicle assembly could be enabled.

Proximate to peripheral edge 30, securing member 32 is preferably provided on main body 20, wherein securing member 32 is preferably elasticized band 34. Although elasticized band 34 is preferred for utilization as securing member 32, any appropriate securing means could alternately be utilized, such as, for exemplary purposes only, a drawstring, snaps, buckle or hook-and-loop fasteners and/or any combination of such securing members. However, it would be preferable, if snaps or other components capable of scratching a chrome surface were included, that such components would be prevented from any surface contact or covered with a suitable protective coating, such as, for exemplary purposes only, rubber.

Main body 20 has outer surface 22 and inner surface 24, wherein outer surface 22 preferably has central display region 26 provided thereon. Preferably, main body 20 is manufactured from a generally flexible fabric-type material having at least minimal insulative qualities, such as, for exemplary purposes only, canvas. Although canvas is preferred, other flame retardant and/or heat resistant materials or combinations thereof could be utilized, or other beneficial materials could be utilized, such as, for exemplary purposes only, cotton outer surface 22 could be secured to chamois inner surface 24, wherein additional polishing benefits are imparted to the components protected therein.

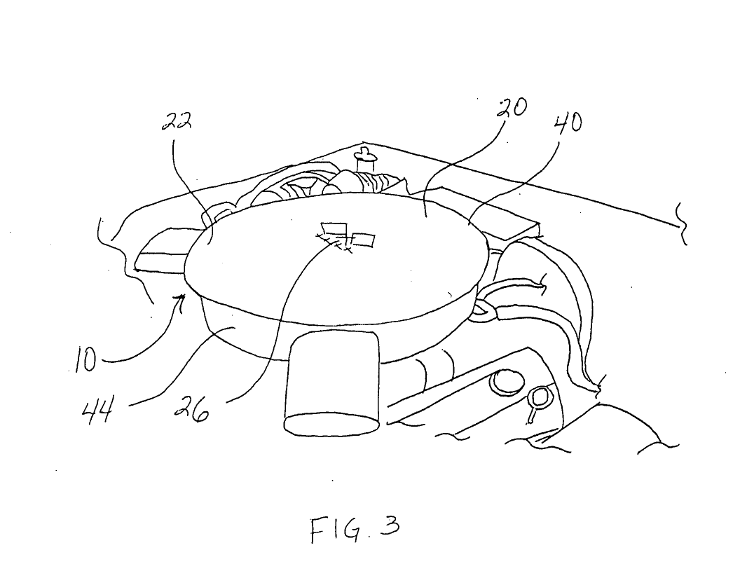

Realized cover diameter 40 is defined within main body 20, wherein three specific realized cover diameters 42a, 42b and 42c (not shown) are preferred for optimal utilization on chrome air filter assembly 44 of CORVETTE C1, CORVETTE C2 and CORVETTE C3, respectively, as depicted in FIG. 3. CORVETTE C1 refers to vehicles manufactured from 1953 to 1962, wherein preferred realized cover diameter 42a therefore is approximately 13½ inches. CORVETTE C2 refers to vehicles manufactured from 1963-1967, wherein preferred realized cover diameter 42b therefore is approximately 21 inches. CORVETTE C3 refers to vehicles manufactured from 1968-1982, wherein preferred realized cover diameter 42c therefore is approximately 24 inches. Although the referenced sizes are preferred to enable essentially customized placement over each of the CORVETTE models referenced, any size could be utilized, wherein conformation and/or adjustability to compensate for variations in air filter assembly diameter could be enabled. The preferred use, as described herein, on CORVETTE C1, CORVETTE C2 and CORVETTE C3, is in recognition of such vehicles typically having a generally extended chrome air filter assembly 44 and fiberglass bodies. However, it is recognized that protective accessory device 10 could be utilized on any engine component in need of such protection, and on any suitable vehicle, that is, CORVETTE's from any year of manufacture and/or any other make or model of vehicle. Additionally, it is noted that preferred realized cover diameter 42b for CORVETTE C2 is particularly suitable for alternative use as a steering wheel cover.

In the preferred use on an air filter assembly, inner surface 24 of main body 20 is positioned proximate to the chrome air filter assembly, wherein outer surface 22 of main body 20 remains visible. Thus, central display region 26 is generally centered over chrome air filter assembly 44. In the preferred embodiment, central display region 26 carries the licensed CORVETTE logo and/or CHEVROLET and/or CORVETTE word marks. Although utilization of CHEVROLET CORVETTE licensed materials is preferred, alternate embodiments could incorporate and display other logos, mascot depictions, emblems, notable coloration, vehicle make or model, sports team, patriotic cause, holiday or any other targeted or custom representation.

In an alternate embodiment, peripheral edge 30 could carry a drawstring, wherein realized cover diameter 40 could be adjustable.

In an alternate embodiment, main body 20 could be color coordinated with the paint and/or coloration style of the vehicle.

In an alternate embodiment, main body 20 could have pockets and/or sleeves defined thereon, wherein use of protective cover device 10 during engine repair could provide a receptacle for tools and the like.

In an alternate embodiment, main body 20 could be shaped to enable placement on other potentially reflective surfaces.

In another alternate embodiment, main body 20 could be shaped to enable placement in open areas, such as a trunk, to decoratively cover goods stored therein.

In still another alternate embodiment, main body 20 could be generally rectangularly shaped, as depicted in FIG. 4, wherein removable placement about the rubber seal of an open trunk would be facilitated, for example, in the generally rectangularly shaped opening of a CORVETTE C5 trunk.

In yet another alternate embodiment, main body 20 could be utilized to decoratively and/or protectively cover any vehicle component, irrespective of the presence or absence of reflective characteristics.

In use, securing member 32 is expanded to enable placement of protective device 10 over preferably chrome air filter assembly 44, wherein release of securing member 32 permits generally resilient peripheral edge 30 to be held substantially proximate to chrome air filter assembly 44. The generally snug fit of main body 20 on chrome air filter assembly 44 provides barrier protection to chrome air filter assembly 44 and limits reflective heat transfer therefrom, while coincidently displaying the message contained within central display region 26.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A protective accessory device for utilization on an air filter assembly of a vehicle, comprising:
a generally circular-shaped fabric body having a visual display surface; and
a retention means carried proximate to a peripheral edge of said generally circular-shaped fabric body,
wherein said generally circular-shaped fabric body has an at least minimal insulative quality and wherein said retention means retains said generally circular-shaped fabric body on the air filter assembly of the vehicle.

2. The protective accessory device of claim 1, wherein said generally circular-shaped fabric body further comprises a flame retardant quality.

3. The protective accessory device of claim 1, wherein said at least minimal insulative quality is sufficient to enable utilization of said protective accessory device on a heated air filter assembly.

4. The protective accessory device of claim 1, wherein said at least minimal insulative quality is sufficient to limit transmission of heat from the surface of a chrome air filter assembly.

5. The protective accessory device of claim 4, wherein said at least minimal insulative quality prevents reflectance of sunlight from a surface of the engine.

6. The protective accessory device of claim 1, wherein said retention means of said generally circular-shaped fabric body is a resilient, elasticized edge.

7. The protective accessory device of claim 1, wherein said retention means of said generally circular-shaped fabric body is a drawstring.

8. The protective accessory device of claim 1, wherein said generally circular-shaped fabric body provides for reduced heat transfer and for scratch resistive qualities.

9. The protective cover of claim 1, wherein said visual display surface carries a display selected from the group of a logo, insignia, mascot, slogan, licensed character, vehicle make, vehicle model, sports team, patriotic cause, or holiday icon.

10. The protective cover of claim 1, wherein said visual display surface carries themed, decorative coloration.

11. The protective accessory of claim 1, wherein said generally circular shaped fabric body defines a realized cover diameter selected from the group of approximately 13.5 inches, approximately 21 inches, and approximately 24 inches.

12. A cover for use in a vehicle compartment, comprising:
a conformable body, said conformable body having an adaptable peripheral edge,
wherein said adaptable peripheral edge enables removably secure placement of said conformable body in a selected position in the vehicle compartment.

13. The cover of claim 12, wherein said conformable body defines a shape selected from the group of circle, square, triangle, oval or rectangle.

14. The cover of claim 12, wherein said adaptable peripheral edge carries a fastening means selected from the group of elasticized band, drawstring, snaps, buckle or hook-and-loop fasteners.

15. The cover of claim 14, further comprising a shield coating for said fastening means.

16. The cover of claim 12, wherein said conformable body is canvas.

17. The cover of claim 12, wherein said conformable body has an interior surface and an exterior surface, said interior surface being chamois.

18. The cover of claim 12, wherein said conformable body has a pocket.

19. A method of advertising and coincidently protecting a fiberglass body of an automobile during display, comprising the steps of:
a. obtaining a protective body with a retention means, said protective body having an advertising display surface, and said protective body dimensioned to be received and retained on a chrome engine component;
b. opening the fiberglass hood of an automobile and exposing said chrome engine component;
c. placing said protective body over said chrome engine component with said display surface of said protective body visible,
wherein said protective body inhibits reflective transmission from said chrome engine component to said fiberglass hood, wherein said protective body limits heat transmission from said chrome engine component to said fiberglass hood, and wherein said protective body prevents physical damage to said chrome engine component.

20. The method of claim 19, wherein said chrome engine component is selected from the group of air filter assembly, distributor assembly, or ignition assembly.
